(19) United States
(12) Patent Application Publication
(10) Pub. No.: US 2015/0205382 A1
(43) Pub. Date: Jul. 23, 2015

(54) TOUCH STYLUS WITH WIRELESS CHARGING FUNCTION AND OPERATING METHOD THEREOF

(71) Applicant: Raydium Semiconductor Corporation, Hsinchu (TW)

(72) Inventors: Chia-Hsiu LIN, Hsinchu City (TW); Te-Chang LIN, Hsinchu City (TW); Ya-Ling LU, Pingtung City (TW); Yi-Ming CHEN, Tainan City (TW); Wei-Yuan CHENG, Taichung City (TW)

(21) Appl. No.: 14/573,433

(22) Filed: Dec. 17, 2014

(30) Foreign Application Priority Data
Jan. 17, 2014 (TW) 103101830

(51) Int. Cl. G06F 3/038; G06F 3/0354

(52) U.S. Cl. CPC G06F 3/0383; G06F 3/03545; G06F 2203/0384

(57) ABSTRACT

A touch stylus with wireless charging function and operating method thereof are disclosed. The touch stylus includes a receiving coil, a resonant circuit, a rectifier circuit, and a voltage regulation output circuit. The receiving coil is used to receive an AC signal from outside. The resonant circuit is coupled to the receiving coil and used to perform a resonant process on the AC signal. The rectifier circuit is coupled to the resonant circuit and used to perform a rectifier process on the resonated AC signal. The voltage regulation output circuit is coupled to the rectifier circuit and used to perform a voltage regulation process on the rectified AC signal to convert the rectified AC signal into an output power for the operation of the touch stylus.

### BACKGROUND OF THE INVENTION

1. Field of the Invention

This invention relates to a touch input apparatus, especially to a touch stylus with wireless charging function and an operating method thereof.

2. Description of the Related Art

In general, a conventional touch stylus can be a passive-type touch stylus with constant power source and it is cooperated with a digital pad. Electromagnetic wave generated by the digital pad provides an AC signal. The passive touch stylus converts the AC signal into a DC signal through a rectifier circuit and a filter capacitor and uses a regulator circuit to process the DC signal to form a constant regulating signal. In addition, the passive-type touch stylus induces the energy of the AC signal through a coil and converts it into electrical energy through a charging circuit.

However, the conventional touch stylus still has following drawbacks:

(1) The conventional touch stylus must be cooperated with the digital pad to obtain the AC signal provided by the electromagnetic wave that the digital pad generates.

(2) Interference between the frequencies of the charging circuit and the AC signal is easily generated.

Therefore, the invention provides a touch stylus with wireless charging function and an operating method thereof to solve the above-mentioned problems.

### SUMMARY OF THE INVENTION

An embodiment of the invention is a touch stylus with wireless charging function. In this embodiment, the touch stylus with wireless charging function includes a receiving coil, a resonant circuit, a rectifier circuit, and a voltage regulation output circuit. The receiving coil is used to receive an AC signal from outside. The resonant circuit is coupled to the receiving coil and used to perform a resonant process on the AC signal. The rectifier circuit is coupled to the resonant circuit and used to perform a rectifier process on the resonated AC signal. The voltage regulation output circuit is coupled to the rectifier circuit and used to perform a voltage regulation process on the rectified AC signal to convert the rectified AC signal into an output power for the operation of the touch stylus.

In this embodiment, the touch stylus further includes a charging battery. The charging battery is coupled to the voltage regulation output circuit and used to store the output power.

In an embodiment, when the touch stylus is disposed in a touch stylus place hole, the receiving coil in the touch stylus will correspond to an emitting coil and receive the AC signal emitted by the emitting coil.

In an embodiment, the touch stylus place hole is disposed on an electronic apparatus.

In an embodiment, the emitting coil is disposed in an emitting circuit, the emitting circuit includes an oscillation circuit, a driving circuit, and a resonant circuit, the emitting coil is coupled to the resonant circuit, the resonant circuit is coupled to the driving circuit, the driving circuit is coupled to the oscillation circuit, the oscillation circuit receives an input power from a power supply and converts the input power into the AC signal, and then the AC signal is processed by the driving circuit and the resonant circuit and emitted by the emitting coil.

In an embodiment, the receiving coil and emitting coil are uniformly and tightly wound and in a positive coupling cylindrical design.

In an embodiment, the AC signal is transmitted between the receiving coil and the emitting coil in an electromagnetic induction way through a half-bridge series resonant circuit, a full-bridge series resonant circuit, or a fly-back circuit.

In an embodiment, height and size of the touch stylus place hole are adjusted according to size of the touch stylus to achieve optimal coupling state between the touch stylus place hole and the touch stylus.

In an embodiment, the touch stylus further includes an outer casing formed by non-conductive material.

Another embodiment of the invention is a touch stylus operating method. In this embodiment, the touch stylus operating method is used to operate a touch stylus with wireless charging function, the touch stylus includes a receiving coil, a resonant circuit, a rectifier circuit, and a voltage regulation output circuit, the touch stylus operating method includes steps of: the receiving coil receiving an AC signal from outside; the resonant circuit performing a resonant process on the AC signal to form a resonated AC signal; the rectifier circuit performing a rectifier process on the resonated AC signal to form a rectified AC signal; and the voltage regulation output circuit performing a voltage regulation process on the rectified AC signal to convert the rectified AC signal into an output power for an operation of the touch stylus.

Compared to the prior art, the touch stylus with wireless charging function and the operating method thereof in the invention have the following advantages:

(1) The touch stylus can be used without the digital pad.

(2) The touch stylus can be continuously used without changing battery.

(3) Since the outer casing of the touch stylus can be formed by non-conductive material, it can be made in a light-weight design.

(4) Since the size of the touch stylus place hole can be adjusted based on the size of the touch stylus, the size of the touch stylus can be designed without limitations.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 and FIG. 2 illustrate functional block diagrams of the touch stylus in different embodiments of the invention.

FIG. 3 illustrates a cross-section of the touch stylus disposed in the touch stylus place hole.

FIG. 4 illustrates a flowchart of the touch stylus operating method in another embodiment of the invention.

### DETAILED DESCRIPTION

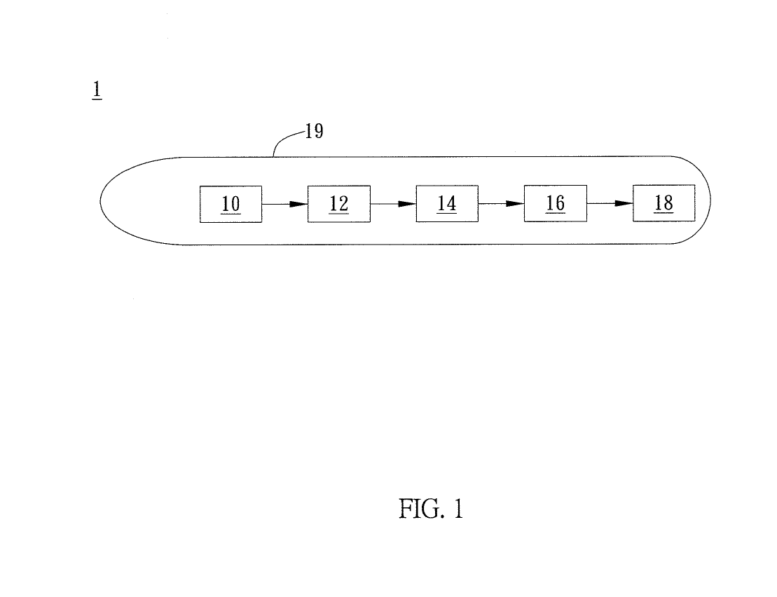

A preferred embodiment of the invention is a touch stylus with wireless charging function. In this embodiment, the touch stylus is used to perform a touch action to a touch panel of an electronic apparatus, but not limited to this. At first, please refer to FIG. 1. FIG. 1 illustrates a functional block diagram of the touch stylus in this embodiment.

As shown in FIG. 1, the touch stylus 1 includes a receiving coil 10, a resonant circuit 12, a rectifier circuit 14, and a voltage regulation output circuit 16. Wherein, the resonant circuit 12 is coupled to the receiving coil 10; the rectifier circuit 14 is coupled to the resonant circuit 12; the voltage regulation output circuit 16 is coupled to the rectifier circuit 14. In practical applications, the touch stylus 1 can further include a charging battery 18. The charging battery 18 can be coupled to the voltage regulation output circuit 16 and used to store the output power outputted by the voltage regulation output circuit 16 and the output power is used for the operation of the touch stylus 1. In addition, since the outer casing of the touch stylus can be formed by non-conductive material, it can be made in a light-weight design.

In this embodiment, the receiving coil 10 receives an AC signal from outside. The resonant circuit 12 performs a resonant process on the AC signal to form a resonated AC signal. The rectifier circuit 14 performs a rectifier process on the resonated AC signal to form a rectified AC signal. The voltage regulation output circuit 16 performs a voltage regulation process on the rectified AC signal to convert the rectified AC signal into an output power for the operation of the touch stylus 1 and output the output power.

Please refer to FIG. 2. FIG. 2 illustrates a functional block diagram of an electronic apparatus having a touch stylus place hole. As shown in FIG. 2, the electronic apparatus 2 includes an emitting circuit 20 and the touch stylus place hole 22. In fact, height and size of the touch stylus place hole 22 can be adjusted according to size of the touch stylus 1 to achieve optimal coupling state between the touch stylus place hole 22 and the touch stylus 1. When the optimal coupling state between the touch stylus place hole 22 and the touch stylus 1 is achieved, the touch stylus 1 or the touch stylus place hole 22 can show an indicating signal or an indicating sound to inform the user.

The emitting circuit 20 includes an emitting coil 200, an oscillation circuit 202, a driving circuit 204, and a resonant circuit 206; the emitting coil 200 is coupled to the resonant circuit 202; the resonant circuit 202 is coupled to the driving circuit 204; the driving circuit 204 is coupled to the oscillation circuit 206. The oscillation circuit 206 receives an input power from a power supply (not shown in figures) and converts the input power into the AC signal, and then the AC signal is processed by the driving circuit 204 and the resonant circuit 22 and emitted by the emitting coil 200.

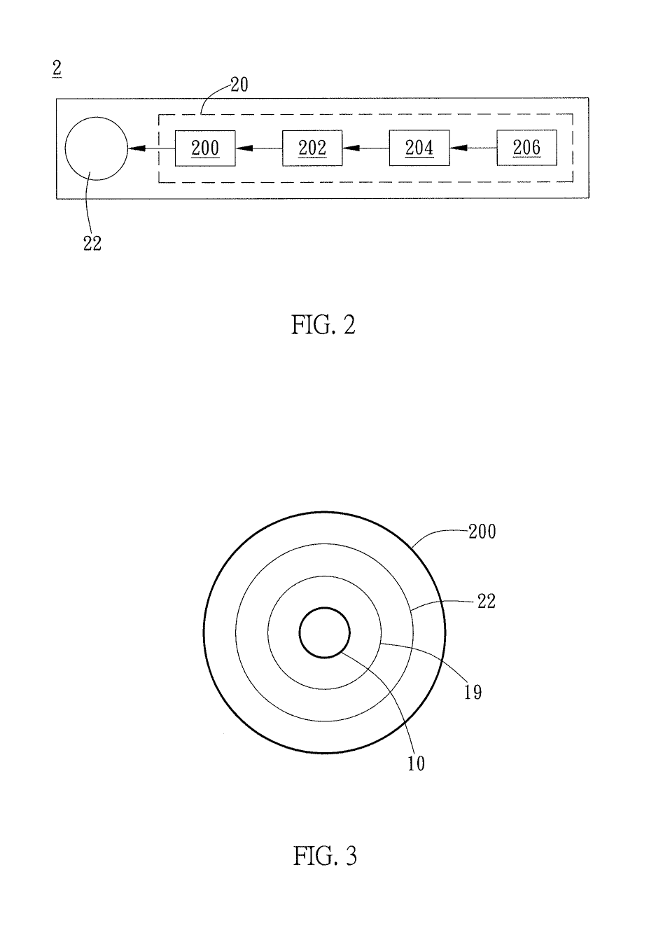

Please refer to FIG. 3. FIG. 3 illustrates a cross-section of the touch stylus disposed in the touch stylus place hole. As shown in FIG. 3, when the touch stylus 1 is disposed in the touch stylus place hole 22, the receiving coil 10 disposed in the outer casing 19 of the touch stylus 1 will correspond to the emitting coil 200 and receive the AC signal emitted by the emitting coil 200.

In practical applications, the receiving coil 10 and emitting coil 200 are uniformly and tightly wound and in a positive coupling cylindrical design. The AC signal is transmitted between the receiving coil 10 and the emitting coil 200 in an electromagnetic induction way through a half-bridge series resonant circuit, a full-bridge series resonant circuit, or a fly-back circuit.

Another embodiment of the invention is a touch stylus operating method. In this embodiment, the touch stylus operating method is used to operate a touch stylus with wireless charging function. The touch stylus includes a receiving coil, a resonant circuit, a rectifier circuit, and a voltage regulation output circuit.

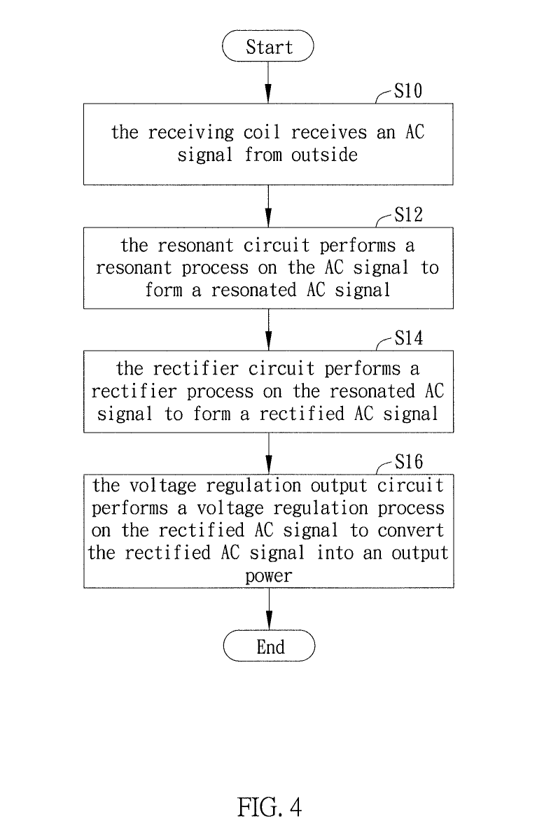

Please refer to FIG. 4. FIG. 4 illustrates a flowchart of the touch stylus operating method in this embodiment. As shown in FIG. 4, in the step S10, the receiving coil receives an AC signal from outside.

In fact, when the touch stylus is disposed in a touch stylus place hole, the receiving coil in the touch stylus corresponds to an emitting coil and receives the AC signal emitted by the emitting coil. The AC signal is transmitted between the receiving coil and the emitting coil in an electromagnetic induction way through a half-bridge series resonant circuit, a full-bridge series resonant circuit, or a fly-back circuit. Height and size of the touch stylus place hole are adjusted according to size of the touch stylus to achieve optimal coupling state between the touch stylus place hole and the touch stylus.

In this embodiment, the emitting coil is disposed in an emitting circuit. The emitting circuit includes an oscillation circuit, a driving circuit, and a resonant circuit. The oscillation circuit receives an input power from a power supply and converts the input power into the AC signal, and then the AC signal is processed by the driving circuit and the resonant circuit and emitted by the emitting coil.

In the step S12, the resonant circuit performs a resonant process on the AC signal to form a resonated AC signal. In the step S14, the rectifier circuit performs a rectifier process on the resonated AC signal to form a rectified AC signal. In the step S16, the voltage regulation output circuit performs a voltage regulation process on the rectified AC signal to convert the rectified AC signal into an output power for an operation of the touch stylus.

Compared to the prior art, the touch stylus with wireless charging function and the operating method thereof in the invention have the following advantages:

(1) The touch stylus can be used without the digital pad.

(2) The touch stylus can be continuously used without changing battery.

(3) Since the outer casing of the touch stylus can be formed by non-conductive material, it can be made in a light-weight design.

(4) Since the size of the touch stylus place hole can be adjusted based on the size of the touch stylus, the size of the touch stylus can be designed without limitations.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch stylus with wireless charging function, comprising:
a receiving coil for receiving an AC signal from outside;
a resonant circuit coupled to the receiving coil, the resonant circuit performing a resonant process on the AC signal to form a resonated AC signal;
a rectifier circuit coupled to the resonant circuit, the rectifier circuit performing a rectifier process on the resonated AC signal to form a rectified AC signal; and
a voltage regulation output circuit coupled to the rectifier circuit, the voltage regulation output circuit performing a voltage regulation process on the rectified AC signal to convert the rectified AC signal into an output power for an operation of the touch stylus.

2. The touch stylus of claim 1, further comprising:
a charging battery coupled to the voltage regulation output circuit, the charging battery storing the output power.

3. The touch stylus of claim 1, wherein when the touch stylus is disposed in a touch stylus place hole, the receiving coil in the touch stylus corresponds to an emitting coil and receives the AC signal emitted by the emitting coil.

4. The touch stylus of claim 3, wherein the touch stylus place hole is disposed on an electronic apparatus.

5. The touch stylus of claim 3, wherein the emitting coil is disposed in an emitting circuit, the emitting circuit comprises an oscillation circuit, a driving circuit, and a resonant circuit, the emitting coil is coupled to the resonant circuit, the resonant circuit is coupled to the driving circuit, the driving circuit is coupled to the oscillation circuit, the oscillation circuit receives an input power from a power supply and converts the input power into the AC signal, and then the AC signal is processed by the driving circuit and the resonant circuit and emitted by the emitting coil.

6. The touch stylus of claim 3, wherein the receiving coil and emitting coil are uniformly and tightly wound and in a positive coupling cylindrical design.

7. The touch stylus of claim 3, wherein the AC signal is transmitted between the receiving coil and the emitting coil in an electromagnetic induction way through a half-bridge series resonant circuit, a full-bridge series resonant circuit, or a fly-back circuit.

8. The touch stylus of claim 3, wherein height and size of the touch stylus place hole are adjusted according to size of the touch stylus to achieve optimal coupling state between the touch stylus place hole and the touch stylus.

9. The touch stylus of claim 3, further comprising:
an outer casing formed by a non-conductive material.

10. A touch stylus operating method, used to operate a touch stylus with wireless charging function, the touch stylus comprising a receiving coil, a resonant circuit, a rectifier circuit, and a voltage regulation output circuit, the touch stylus operating method comprising steps of:
the receiving coil receiving an AC signal from outside;
the resonant circuit performing a resonant process on the AC signal to form a resonated AC signal;
the rectifier circuit performing a rectifier process on the resonated AC signal to form a rectified AC signal; and
the voltage regulation output circuit performing a voltage regulation process on the rectified AC signal to convert the rectified AC signal into an output power for an operation of the touch stylus.

11. The touch stylus operating method of claim 10, further comprising a step of:
when the touch stylus is disposed in a touch stylus place hole, the receiving coil in the touch stylus corresponding to an emitting coil and receiving the AC signal emitted by the emitting coil.

12. The touch stylus operating method of claim 11, wherein the emitting coil is disposed in an emitting circuit, the emitting circuit comprises an oscillation circuit, a driving circuit, and a resonant circuit, the touch stylus operating method further comprises a step of:
the oscillation circuit receiving an input power from a power supply and converting the input power into the AC signal, and then the driving circuit and the resonant circuit processing the AC signal and the emitting coil emitting the AC signal.

13. The touch stylus operating method of claim 11, wherein the AC signal is transmitted between the receiving coil and the emitting coil in an electromagnetic induction way through a half-bridge series resonant circuit, a full-bridge series resonant circuit, or a fly-back circuit.

14. The touch stylus operating method of claim 11, wherein height and size of the touch stylus place hole are adjusted according to size of the touch stylus to achieve optimal coupling state between the touch stylus place hole and the touch stylus.
